(19) United States
(12) Patent Application Publication
(10) Pub. No.: US 2025/0163234 A1
(43) Pub. Date: May 22, 2025

(54) HEAT-EXPANDABLE MICROSPHERES AND USE THEREOF

(71) Applicant: MATSUMOTO YUSHI-SEIYAKU CO., LTD., Yao-shi, Osaka (JP)

(72) Inventors: Naoya SHIMIZU, Yao-shi, Osaka (JP); Tomoya UDA, Yao-shi, Osaka (JP); Jun TAKEUCHI, Yao-shi, Osaka (JP)

(73) Assignee: MATSUMOTO YUSHI-SEIYAKU CO., LTD., Yao-shi, Osaka (JP)

(21) Appl. No.: 18/840,157

(22) PCT Filed: Feb. 20, 2023
(86) PCT No.: PCT/JP2023/005882

§ 371 Date: Aug. 21, 2024

(30) Foreign Application Priority Data
Feb. 24, 2022 (JP) 2022-026280

(51) Int. Cl. C08J 9/32; B01J 13/14; C08F 2/44; C08F 214/08; C08F 220/44

(52) U.S. Cl. CPC C08J 9/32; B01J 13/14; C08F 2/44; C08F 214/08; C08F 220/44

(57) ABSTRACT

Heat-expandable microspheres include: an outer shell containing a thermoplastic resin; and a blowing agent that is encapsulated in the outer shell and vaporizes by heating, wherein the thermoplastic resin is a polymer of a polymerizable component containing vinylidene chloride (A) and acrylonitrile (B), and the heat-expandable microspheres satisfy conditions 1 and 2 discloses herein. The total weight ratio of the vinylidene chloride (A) and the acrylonitrile (B) in the polymerizable component is preferably 55 to 99.9 wt %.

### CROSS-REFERENCE TO RELATED APPLICATIONS

This application is a National Stage of International Application No. PCT/JP2023/005882 filed Feb. 20, 2023, claiming priority from Japanese Patent Application No. 2022-026280 filed Feb. 24, 2022.

### BACKGROUND OF THE INVENTION

### Field of the Invention

The present invention relates to heat-expandable microspheres and use thereof.

### Description of the Related Art

The heat-expandable microspheres (heat-expandable microcapsules) have a structure in which a thermoplastic resin is used as an outer shell and a blowing agent is encapsulated in the outer shell. The heat-expandable microspheres are microspheres having a feature of expanding by applying heat treatment.

The heat-expandable microspheres are used in a wide range of applications, and for example, the heat-expandable microspheres are blended in a base material and then used for heating processing. In the heat processing, the heat-expandable microspheres expand due to heat treatment applied during the processing, and can not only reduce the weight of a processed product but also impart designability, cushioning properties, and the like to the processed product.

For example, Patent Literature 1 exemplifies heat-expandable microspheres having high expansion performance, the heat-expandable microspheres produced by using an outer shell composed of a copolymer of a monomer selected from acrylonitrile, methacrylonitrile, an acrylic acid ester, and a methacrylic acid ester or the like, and using a hydrocarbon such as isobutane or isopentane as a blowing agent.
Patent Literature 1: WO 2007/091961

### Problems to be Solved by the Invention

However, in the heat-expandable microspheres disclosed in Patent Literature 1 described above, a problem may occur that a blowing agent leaks out over time from hollow particles that are obtained by expanding the heat-expandable microspheres and that have a thin outer shell portion.

### SUMMARY OF THE INVENTION

An object of the present invention is to provide heat-expandable microspheres capable of obtaining hollow particles capable of reducing leakage of a blowing agent over time, and use thereof.

As a result of intensive studies, the present inventors have discovered that the above-described problem can be solved by heat-expandable microspheres including: an outer shell containing a thermoplastic resin obtained by polymerizing a specific polymerizable component; and a blowing agent that is encapsulated in the outer shell and vaporizes by heating, wherein a temperature at which a derivative thermogravimetric curve of the heat-expandable microspheres measured by a specific method is maximized and an expansion-starting temperature of the heat-expandable microspheres show a specific relationship, and have achieved the present invention.

The present invention includes the following aspects <1> to <8>.

<1> Heat-expandable microspheres including: an outer shell containing a thermoplastic resin; and a blowing agent that is encapsulated in the outer shell and vaporizes by heating, wherein the thermoplastic resin is a polymer of a polymerizable component containing vinylidene chloride (A) and acrylonitrile (B), and the heat-expandable microspheres satisfy the following conditions 1 and 2:
condition 1: a weight ratio of the vinylidene chloride (A) and the acrylonitrile (B) in the polymerizable component has a relationship of Formula (I):

$$the weight ratio of the acrylonitrile ( B ) / the weight ratio of the vinylidene chloride ( A ) > 1 \qquad Formula ( I )$$

condition 2: in a derivative thermogravimetric curve (DTG) obtained by heating the heat-expandable microspheres by thermogravimetric analysis (TGA) at 10° C./min in a nitrogen atmosphere, a temperature (Td(° C.)) at which a DTG value is maximized and an expansion-starting temperature (Ts(° C.)) have a relationship of Formula (II):

$$the temperature at which the D T G value is maximized ( Td ( ° C . ) ) - the expansion - starting temperature ( Ts ( ° C . ) ) \geq 30 ° C .. \qquad Formula ( II )$$

<2> The heat-expandable microspheres according to <1>, wherein a total weight ratio of the vinylidene chloride (A) and the acrylonitrile (B) in the polymerizable component is 55 to 99.9 wt %.

<3> The heat-expandable microspheres according to <1> or <2>, wherein a weight ratio of the acrylonitrile (B) in the polymerizable component is 40 to 70 wt %.

<4> Fine-particle-coated heat-expandable microspheres including: the heat-expandable microspheres according to any one of <1> to <3>; and fine particles coating an outer surface of an outer shell portion of the heat-expandable microspheres.

<5> Hollow particles produced by expanding the heat-expandable microspheres according to any one of <1> to <3>.

<6: Fine-particle-coated hollow particles including: the hollow particles according to <5>; and fine particles coating an outer surface of an outer shell portion of the hollow particles.

<7> A composition including: at least one selected from the heat-expandable microspheres according to any one of <1> to <3>, the fine-particle-coated heat-expandable microspheres according to <4>, the hollow particles according to <5>, and the fine-particle-coated hollow particles according to <6>; and a base material component.

<8> A molded article obtained by molding the composition according to <7>.

The composition of the present invention includes at least one selected from the heat-expandable microspheres, the fine-particle-coated heat-expandable microspheres, the hollow particles, and the fine-particle-coated hollow particles, and a base material component.

The molded article of the present invention is obtained by molding the composition.

### Advantageous Effects of the Invention

The heat-expandable microspheres of the present invention provide hollow particles capable of reducing leakage of a blowing agent over time.

The heat-expandable microspheres of the present invention can start to expand at a relatively low temperature.

The fine-particle-coated heat-expandable microspheres of the present invention provide fine-particle-coated hollow particles capable of reducing leakage of a blowing agent over time.

The fine-particle-coated heat-expandable microspheres of the present invention can start to expand at a relatively low temperature.

The hollow particles of the present invention are obtained using the heat-expandable microspheres as a raw material, and thus can reduce leakage of a blowing agent over time.

The fine-particle-coated hollow particles of the present invention are obtained using at least one selected from the heat-expandable microspheres and the fine-particle-coated heat-expandable microspheres as a raw material, and thus can reduce leakage of a blowing agent over time.

The composition of the present invention contains at least one selected from the heat-expandable microspheres, the hollow particles, and the fine-particle-coated hollow particles, and thus can provide a lightweight molded article.

The molded article of the present invention is lightweight.

### BRIEF DESCRIPTION OF THE DRAWINGS

FIG. 1 is a schematic view illustrating an example of heat-expandable microspheres.

FIG. 2 is a schematic view illustrating an example of fine-particle-coated hollow particles.

FIG. 3 is a schematic view illustrating an example of fine-particle-coated heat-expandable microspheres.

### REFERENCE NUMBERS LIST

Reference numbers used to identify various features in the drawings include the following:
1 Fine-particle-coated hollow particles
2 Outer shell portion
3 Hollow portion
4 Fine particles (adsorbed state)
5 Fine particles (embedded and fixed state)
6 Outer shell (shell)
7 Blowing agent (core)
8 Fine-particle-coated heat-expandable microspheres
9 Outer shell portion (shell)
10 Blowing agent (core)
11 Fine particles (adsorbed state)
12 Fine particles (embedded and fixed state)

### DETAILED DESCRIPTION OF PREFERRED EMBODIMENTS

### [Heat-Expandable Microspheres]

The heat-expandable microspheres of the present invention are specifically described as follows and in reference to the drawings. However, the present invention should not be construed as being limited thereto.

The heat-expandable microspheres of the present invention each include: an outer shell containing a thermoplastic resin; and a blowing agent that is encapsulated in the outer shell and vaporizes by heating. The heat-expandable microspheres exhibit heat expandability as the entire microspheres (properties that the entire microspheres expand by heating).

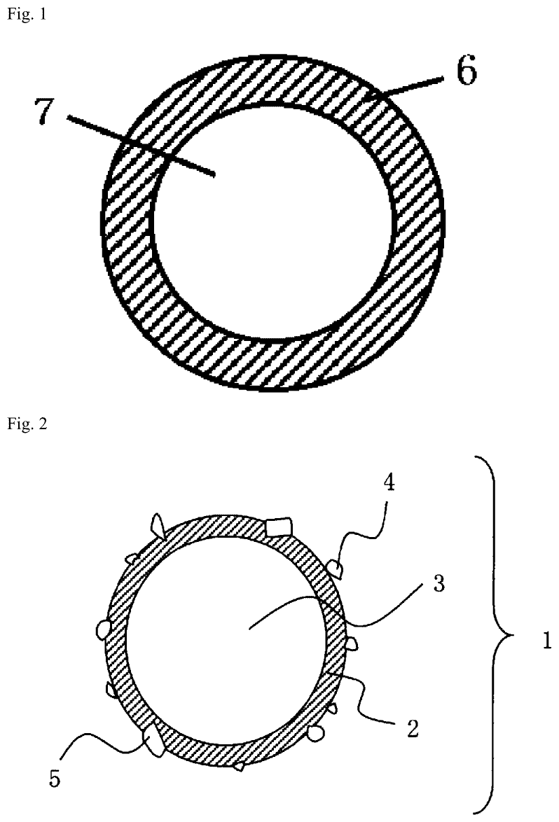

As illustrated in FIG. 1, the heat-expandable microspheres of the present invention each have a core-shell structure composed of an outer shell (shell) 6 and a blowing agent (core) 7.

In the outer shell constituting the heat-expandable microspheres of the present invention, the thermoplastic resin forming the outer shell is a polymer obtained by polymerizing a polymerizable component.

The polymerizable component is a component that contains a monomer component as an essential component, and optionally contains a cross-linking agent. The monomer component means a monomer having one polymerizable carbon-carbon double bond (hereinafter, may be simply referred to as a monomer), and is an addition-polymerizable component. The cross-linking agent means a monomer having at least two polymerizable carbon-carbon double bonds, and is a component that introduces a cross linked structure into the thermoplastic resin.

The polymerizable component contains vinylidene chloride (A) (hereinafter, may be referred to as a monomer (A)) and acrylonitrile (B) (hereinafter, may be referred to as a monomer (B)).

The polymerizable component contains the vinylidene chloride (A), and can be the heat-expandable microspheres having excellent expandability even in a relatively low temperature range.

The polymerizable component contains the acrylonitrile (B), and the heat-expandable microspheres can have good heat resistance.

Further, the heat-expandable microspheres of the present invention satisfy the following conditions 1 and 2. By satisfying these conditions, the thermoplastic resin can have gas barrier properties, elasticity during heating and softening, stretchability, and heat resistance. Then, the heat-expandable microspheres expand at a relatively low temperature due to the balance of the properties. Thus, the gas barrier properties of the outer shell of the hollow particles prepared by expanding the heat-expandable microspheres are high, and the permeation of the blowing agent to the outside of the outer shell can be reduced, resulting in excellent retention of the blowing agent.

The heat-expandable microspheres of the present invention satisfy the following condition 1.

condition 1: the weight ratio of vinylidene chloride (A) and acrylonitrile (B) in the polymerizable component has a relationship of the following Formula (I):

$$the weight ratio of the acrylonitrile ( B ) / the weight ratio of the vinylidene chloride ( A ) > 1 \qquad Formula ( I )$$

In the condition 1, when the monomer (A) and the monomer (B) do not satisfy the above Formula (I), that is, when the “weight ratio of monomer (B)/weight ratio of monomer (A) ((B)/(A))≤1”, it is considered that random polymerization of the monomer (A) and the monomer (B) in the polymer does not proceed at an appropriate ratio, and thus the gas barrier properties of the outer shell of the hollow particles prepared by expansion are deteriorated and the retention of the blowing agent is deteriorated, resulting in leakage of the blowing agent over time, and further, the expandability at low temperatures is deteriorated.

The upper limit of the ratio (B)/(A) is preferably (1) 10, (2) 7, (3) 5, (4) 4.5, and (5) 2 in this order (it is more preferable as the number in parentheses increases). On the other hand, the lower limit of the ratio (B)/(A) is preferably (1) 1.05, (2) 1.1, (3) 1.14, (4) 1.2, and (5) 1.4 in this order (it is more preferable as the number in parentheses increases). Further, the ratio (B)/(A) is, for example, preferably more than 1 to 10, more preferably 1.2 to 4.5, and particularly preferably 1.4 to 2.

The weight ratio of the monomer (A) in the polymerizable component is not particularly limited as long as the condition 1 is satisfied, but is preferably 5 to 49.9 wt % from the viewpoint of exhibiting the effect of the present application. The upper limit of the weight ratio is more preferably 45 wt %, still more preferably 40 wt %, and particularly preferably 35 wt %. The lower limit of the weight ratio is more preferably 15 wt %, still more preferably 20 wt %, and particularly preferably 25 wt %. Further, the weight ratio is, for example, more preferably 15 to 45 wt %, and particularly preferably 25 to 35 wt %.

The weight ratio of the monomer (B) in the polymerizable component is not particularly limited as long as the condition 1 is satisfied, but is preferably 20 to 80 wt % from the viewpoint of exhibiting the effect of the present application. The upper limit of the weight ratio is more preferably 75 wt %, still more preferably 70 wt %, particularly preferably 65 wt %, and most preferably 60 wt %. On the other hand, the lower limit of the weight ratio is more preferably 25 wt %, still more preferably 30 wt %, particularly preferably 35 wt %, and most preferably 40 wt %. Further, the weight ratio is, for example, more preferably 30 to 75 wt %, and particularly preferably 40 to 60 wt %.

The total weight ratio of the monomer (A) and the monomer (B) in the polymerizable component is not particularly limited, but is preferably 55 to 99.9 wt % from the viewpoint of exhibiting the effect of the present application. The upper limit of the weight ratio is more preferably 96 wt %, still more preferably 93 wt %, and particularly preferably 90 wt %. On the other hand, the lower limit of the weight ratio is more preferably 60 wt %, still more preferably 65 wt %, and preferably 70 wt %. Further, the weight ratio is, for example, more preferably 60 to 96 wt %, and particularly preferably 70 to 90 wt %.

The polymerizable component preferably contains another monomer (C) (hereinafter, may be referred to as a monomer (C)) having one carbon-carbon double bond other than the monomer (A) and the monomer (B), from the viewpoint of stable production of the heat-expandable microspheres of the present application.

When the polymerizable component contains another monomer (C), the weight ratio of the monomer (C)/the weight ratio of the monomer (A) ((C)/(A)) in the polymerizable component is preferably 10 to 200% from the viewpoint of exhibiting the effect of the present application. The upper limit of the weight ratio (C)/(A) is more preferably 170%, still more preferably 140%, particularly preferably 110%, and most preferably 70%. On the other hand, the lower limit of the weight ratio (C)/(A) is more preferably 15%, still more preferably 20%, particularly preferably 25%, and most preferably 30%. Further, the weight ratio (C)/(A) is, for example, more preferably 15 to 110%, and particularly preferably 30 to 70%.

Examples of the other monomer (C) include nitrile-based monomers other than acrylonitrile, such as methacrylonitrile, fumaronitrile, and maleonitrile; vinyl halide-based monomers such as vinyl chloride; vinylidene halide-based monomers other than vinylidene chloride; vinyl ester-based monomers such as vinyl acetate, vinyl propionate, and vinyl butyrate; carboxyl group-containing monomers such as unsaturated monocarboxylic acids including acrylic acid, methacrylic acid, ethacrylic acid, crotonic acid, and cinnamic acid, unsaturated dicarboxylic acids including maleic acid, itaconic acid, fumaric acid, citraconic acid, and chloromaleic acid, anhydrides of unsaturated dicarboxylic acids, and unsaturated dicarboxylic acid monoesters including monomethyl maleate, monoethyl maleate, monobutyl maleate, monomethyl fumarate, monoethyl fumarate, monomethyl itaconate, monoethyl itaconate, and monobutyl itaconate; (meth)acrylic acid ester-based monomers such as methyl (meth)acrylate, ethyl (meth)acrylate, n-butyl (meth)acrylate, t-butyl (meth)acrylate, isobutyl (meth)acrylate, 2-ethylhexyl (meth)acrylate, lauryl (meth)acrylate, stearyl (meth)acrylate, phenyl (meth)acrylate, isobornyl (meth)acrylate, cyclohexyl (meth)acrylate, benzyl (meth)acrylate, 2-hydroxyethyl (meth)acrylate, and 2-hydroxypropyl (meth)acrylate; (meth)acrylamide-based monomers such as acrylamide, substituted acrylamide, methacrylamide, and substituted methacrylamide; maleimide-based monomers such as N-phenylmaleimide and N-cyclohexylmaleimide; styrene-based monomers such as styrene and α-methylstyrene; ethylenically-unsaturated monoolefin-based monomers such as ethylene, propylene, and isobutylene; vinyl ether-based monomers such as vinyl methyl ether, vinyl ethyl ether, and vinyl isobutyl ether; vinyl ketone-based monomers such as vinyl methyl ketone; N-vinyl-based monomers such as N-vinylcarbazole and N-vinylpyrrolidone; and vinylnaphthalene. In the carboxyl group-containing monomer, some or all of the carboxyl groups may be neutralized during or after polymerization. In the present invention, acrylic acid or methacrylic acid may be collectively referred to as (meth)acrylic acid, and (meth)acrylic means acrylic or methacrylic. These other monomer components may be used alone or in combination of two or more thereof.

The polymerizable component may further contain a (meth)acrylic acid ester-based monomer as a monomer component. When the polymerizable component further contains the (meth)acrylic acid ester-based monomer, an expansion ratio of the heat-expandable microspheres is improved, which is preferable.

When the polymerizable component contains the (meth)acrylic acid ester-based monomer, the weight ratio of the (meth)acrylic acid ester-based monomer in the polymerizable component is not particularly limited, but is preferably 0 to 45 wt % from the viewpoint of exhibiting the effect of the present application. The upper limit of the weight ratio is more preferably 40 wt %, still more preferably 35 wt %, particularly preferably 30 wt %, and most preferably 25 wt %. On the other hand, the lower limit of the weight ratio is more preferably 3 wt %, still more preferably 7 wt %, particularly preferably 10 wt %, and most preferably 13 wt %. Further, the weight ratio is, for example, more preferably 3 to 40 wt %, and particularly preferably 13 to 25 wt %.

The (meth)acrylic acid ester-based monomer preferably contains at least one selected from methyl methacrylate, methyl acrylate, ethyl acrylate, and butyl acrylate because the expandability at low temperatures is improved. The (meth)acrylic acid ester-based monomer more preferably contains at least one selected from methyl methacrylate and methyl acrylate, and still more preferably contains methyl methacrylate.

When the (meth)acrylic acid ester-based monomer contains methyl methacrylate, the total weight ratio of methyl methacrylate in the (meth)acrylic acid ester is not particularly limited, but is preferably 0 wt % or more from the viewpoint of production stability. The upper limit of the weight ratio is more preferably 100 wt %, still more preferably 97 wt %, and particularly preferably 95 wt %. On the other hand, the lower limit of the weight ratio is more preferably 20 wt %, and still more preferably 40 wt %, and particularly preferably 60 wt %. Further, the weight ratio is, for example, more preferably 20 to 100 wt %, and particularly preferably 60 to 95 wt %.

When the (meth)acrylic acid ester-based monomer contains methyl acrylate, the weight ratio of methyl acrylate in the (meth)acrylic acid ester is not particularly limited, but is preferably 0 wt % or more from the viewpoint of exhibiting the effect of the present application. The upper limit of the weight ratio is more preferably 100 wt %, still more preferably 65 wt %, and particularly preferably 30 wt %. On the other hand, the lower limit of the weight ratio is more preferably 3 wt %, and still more preferably 6 wt % and particularly preferably 9 wt %. Further, the weight ratio is, for example, more preferably 3 to 65 wt %, and particularly preferably 9 to 30 wt %.

The polymerizable component may further contain a nitrile-based monomer other than acrylonitrile as a monomer component. When the polymerizable component further contains the nitrile-based monomer other than acrylonitrile, a solvent resistance of the heat-expandable microspheres is improved, which is preferable.

When the polymerizable component contains the nitrile-based monomer other than acrylonitrile, the weight ratio of the nitrile-based monomer other than acrylonitrile in the polymerizable component is not particularly limited, but is preferably 0 to 35 wt % from the viewpoint of exhibiting the effect of the present application. The upper limit of the weight ratio is more preferably 30 wt %, still more preferably 25 wt %, and particularly preferably 20 wt %.

The nitrile-based monomer other than acrylonitrile preferably contains methacrylonitrile from the viewpoint that the expansion ratio of the heat-expandable microspheres can be adjusted.

When the nitrile-based monomer other than acrylonitrile contains methacrylonitrile, the weight ratio of methacrylonitrile in the nitrile-based monomer other than acrylonitrile is not particularly limited, but is preferably 0 wt % or more from the viewpoint of exhibiting the effect of the present application. The upper limit of the weight ratio is more preferably 100 wt %, still more preferably 70 wt %, and particularly preferably 40 wt %. On the other hand, the lower limit of the weight ratio is more preferably 5 wt %, and still more preferably 10 wt %, and particularly preferably 15 wt %. Further, the weight ratio is, for example, more preferably 5 to 70 wt %, and particularly preferably 15 to 40 wt %.

The polymerizable component may further contain a carboxyl group-containing monomer as a monomer component. When the polymerizable component further contains the carboxyl group-containing monomer, the stretchability of the resulting thermoplastic resin during thermal expansion is improved, which is preferable.

When the polymerizable component contains the carboxyl group-containing monomer, the weight ratio of the carboxyl group-containing monomer in the polymerizable component is not particularly limited, but is preferably 0 to 25 wt % from the viewpoint of exhibiting the effect of the present application. The upper limit of the weight ratio is more preferably 22 wt %, still more preferably 19 wt %, and particularly preferably 16 wt %. On the other hand, the lower limit of the weight ratio is more preferably 2 wt %, still more preferably 4 wt %, and particularly preferably 6 wt %.

The polymerizable component may further contain a (meth)acrylamide-based monomer as a monomer component. When the polymerizable component further contains the (meth)acrylamide-based monomer, the heat resistance of the resulting thermoplastic resin during thermal expansion is improved, which is preferable.

When the polymerizable component contains the (meth)acrylamide-based monomer, the weight ratio of the (meth)acrylamide-based monomer in the polymerizable component is not particularly limited, but is preferably 0 to 25 wt %. The upper limit of the weight ratio is more preferably 22 wt %, still more preferably 19 wt %, and particularly preferably 16 wt %. On the other hand, the lower limit of the weight ratio is more preferably 2 wt %, still more preferably 4 wt %, and particularly preferably 6 wt %.

As described above, the polymerizable component may contain the cross-linking agent. When the polymerizable component contains the cross-linking agent, a decrease in the retention rate (encapsulation retention rate) of the blowing agent encapsulated in the resulting heat-expandable microspheres during thermal expansion is suppressed, and the heat-expandable microspheres can be effectively thermally expanded, which is preferable.

The cross-linking agent is not particularly limited, and examples thereof include aromatic divinyl compounds such as divinylbenzene; alkanediol di(meth)acrylates such as ethylene glycol di(meth)acrylate, 1,4-butanediol di(meth)acrylate, 1,6-hexanediol di(meth)acrylate, 1,9-nonanediol di(meth)acrylate, 1,10-decanediol di(meth)acrylate, neopentyl glycol di(meth)acrylate, 3-methyl-1,5-pentanediol di(meth)acrylate, and 2-methyl-1,8-octanediol di(meth)acrylate; polyalkylene glycol di(meth)acrylates such as diethylene glycol di(meth)acrylate, triethylene glycol di(meth)acrylate, PEG #200 di(meth)acrylate (#200 in the compound name represents that the weight average molecular weight of a polyethylene glycol chain moiety in the molecule is 200, and the same applies to the #Arabic numeral described below), PEG #400 di(meth)acrylate, PEG #600 di(meth)acrylate, PEG #1000 di(meth)acrylate, dipropylene glycol di(meth)acrylate, tripropylene glycol di(meth)acrylate, polypropylene glycol #400 di(meth)acrylate, polypropylene glycol #700 di(meth)acrylate, polytetramethylene glycol di(meth)acrylate, polytetramethylene glycol #650 di(meth)acrylate, and ethoxylated polypropylene glycol #700 di(meth)acrylate; and bifunctional cross linkable monomers, trifunctional cross-linkable monomers, and tetrafunctional or higher cross-linkable monomers, such as ethoxylated bisphenol A di(meth)acrylate (EO addition: 2 to 30), propoxylated bisphenol A di(meth)acrylate (PO addition: 2 to 30), propoxylated ethoxylated bisphenol A di(meth)acrylate, glycerin di(meth)acrylate, 2-hydroxy-3-acryloyloxypropyl methacrylate, dimethylol-tricyclodecane di(meth)acrylate, divinylbenzene, ethoxylated glycerin triacrylate, 1,3,5-tri(meth)acryloyl hexahydro-1,3,5-triazine, triallyl isocyanurate, pentaerythritol tri(meth)acrylate, trimethylolpropane tri(meth)acrylate, 1,2,4-trivinylbenzene, ditrimethylolpropane tetra(meth)acrylate, pentaerythritol tetra(meth)acrylate, and dipentaerythritol hexa(meth)acrylate. The cross-linking agent may be used alone or in combination of two or more thereof.

The weight ratio of the cross-linking agent in the polymerizable component is not particularly limited, but is preferably 0 to 5.0 parts by weight from the viewpoint of improving the expansion ratio of the heat-expandable microcapsules. The upper limit of the weight ratio is more preferably 3.5 wt %, still more preferably 2.0 wt %, and particularly preferably 1.0 wt %. On the other hand, the lower limit of the weight ratio is more preferably 0.04 wt %, still more preferably 0.07 wt %, and particularly preferably 0.1 wt %.

The heat-expandable microspheres of the present invention satisfy the following condition 2.

condition 2: in a derivative thermogravimetric curve (DTG) obtained by heating the heat-expandable microspheres by thermogravimetric analysis (TGA) at 10° C./min in a nitrogen atmosphere, a temperature (Td(° C.)) at which a DTG value is maximized and an expansion-starting temperature (Ts(C)) have a relationship of Formula (II):

$$the temperature at which the D T G value is maximized ( Td ( ° C . ) ) - the expansion - starting temperature ( Ts ( ° C . ) ) \geq 30 ° C .. \qquad Formula ( II )$$

In the condition 2, when the temperature (Td(C)) at which the DTG value is maximized and the expansion-starting temperature (Ts(° C.)) do not satisfy the above Formula (II), that is, when “Td(° C.)−Ts(° C.)<30° C.”, it is considered that the orientation of the polymer does not appropriately proceed when the outer shell is stretched and thinned by thermally expanding the heat-expandable microspheres, and thus the gas barrier properties of the outer shell of the hollow particles prepared by expansion are deteriorated and the retention of the blowing agent is deteriorated, resulting in leakage of the blowing agent over time. Note that the temperature (Td (° C.)) at which the DTG value is maximized and the expansion-starting temperature (Ts (° C.)) are determined by the method described in the Examples of the present invention.

The lower limit of the numerical value of Td(C)−Ts(° C.) is preferably 33° C., more preferably 36° C., and still more preferably 40° C. On the other hand, the upper limit of the numerical value is preferably 100° C., more preferably 70° C., and still more preferably 55° C. Further, the numerical value of Td(° C.)−Ts(° C.) is, for example, more preferably 30 to 100° C., still more preferably 33 to 70° C., and particularly preferably 40 to 55° C.

Td(° C.)−Ts(° C.) in the condition 2 can be adjusted, for example, by changing the contents of the vinylidene chloride (A) and the acrylonitrile (B) contained in the polymerizable component, the type and content of the cross-linking agent, the type of the initiator, and cooling of the reaction solution in the polymerization and the decompression method.

The temperature (Td(° C.)) at which the DTG value is maximized is not particularly limited as long as the condition 2 is satisfied, but is preferably 105 to 250° C. from the viewpoint of exhibiting the effect of the present application. The lower limit of the temperature (Td(C)) is more preferably 115° C., still more preferably 125° C., and particularly preferably 130° C. On the other hand, the upper limit of the temperature (Td(° C.)) is more preferably 180° C., still more preferably 160° C., and particularly preferably 150° C. Further, the temperature Td(° C.) is more preferably, for example, 115 to 180° C., and particularly preferably 130 to 150° C.

The expansion-starting temperature (Ts(° C.)) of the heat-expandable microspheres is not particularly limited as long as the condition 2 is satisfied, but is preferably 75° C. to 220° C. from the viewpoint of improving the expandability at low temperatures of the heat-expandable microspheres. The lower limit of the expansion-starting temperature is more preferably 75° C., still more preferably 78° C., particularly preferably 85° C., and most preferably 90° C. On the other hand, the upper limit of the expansion-starting temperature is more preferably 200° C., still more preferably 180° C., particularly preferably 160° C., and most preferably 150° C. Further, the temperature Ts (° C.) is more preferably, for example, 85 to 180° C., and particularly preferably 90 to 150° C.

A maximum expansion temperature (Tm(° C.)) of the heat-expandable microspheres is not particularly limited, but is preferably 85 to 350° C. from the viewpoint of improving the heat resistance of the heat-expandable microspheres. The lower limit of the maximum expansion temperature is more preferably 90° C., still more preferably 95° C., particularly preferably 100° C. or higher, and most preferably 105° C. On the other hand, the upper limit of the maximum expansion temperature is more preferably 300° C., still more preferably 250° C., particularly preferably 200° C., and most preferably 170° C. The maximum expansion temperature (Tm(° C.)) is determined by the method described in the Examples of the present invention.

The blowing agent is a component that vaporizes when heated, and when the blowing agent is encapsulated in the outer shell constituting the heat-expandable microspheres, the heat-expandable microspheres exhibit heat expandability as the entire microspheres (properties that the entire microspheres expand by heating).

The blowing agent is not particularly limited, but may be linear hydrocarbons such as propane, butane, pentane, hexane, heptane, octane, nonane, decane, dodecane, tridecane, tetradecane, pentadecane, hexadecane, heptadecane, octadecane, and nonadecane; branched hydrocarbons such as isobutane, isopentane, isohexane, isoheptane, isooctane, isononane, isodecane, isododecane, 3-methylundecane, isotridecane, 4-methyldodecane, isotetradecane, isopentadecane, isohexadecane, 2,2,4,4,6,8,8-heptamethylnonane, isoheptadecane, isooctadecane, isononadecane, and 2,6,10,14-tetramethylpentadecane; hydrocarbons such as cyclododecane, cyclotridecane, hexylcyclohexane, heptylcyclohexane, n-octylcyclohexane, cyclopentadecane, nonylcyclohexane, decylcyclohexane, pentadecylcyclohexane, hexadecylcyclohexane, heptadecylcyclohexane, and octadecylcyclohexane; petroleum ethers; halides thereof; fluorine-containing compounds such as hydrofluoroether and fluorocarbon; tetraalkylsilanes; and compounds which are thermally decomposed by heating to produce a gas. The blowing agent may be a linear, branched, or alicyclic compound, and is preferably an aliphatic compound. These blowing agents may be used alone or in combination of two or more thereof.

Among the blowing agents, the blowing agent containing a hydrocarbon having 5 or less carbon atoms is preferable because the expandability at low temperatures of the heat-expandable microspheres can be improved. On the other hand, when the blowing agent contains a hydrocarbon having 6 or more carbon atoms, the expansion-starting temperature and the maximum expansion temperature of the heat-expandable microspheres can be improved. The hydrocarbon having 5 or less carbon atoms is preferably isobutane or isopentane. On the other hand, the hydrocarbon having 6 or more carbon atoms is preferably isooctane.

The blowing agent preferably contains a hydrocarbon having 4 or less carbon atoms, particularly isobutane from the viewpoint of exhibiting the effect of the present application.

An encapsulation ratio of the blowing agent in the heat-expandable microspheres is defined as the percentage of the weight of the blowing agent encapsulated in the heat-expandable microspheres with respect to the weight of the heat-expandable microspheres.

The encapsulation ratio of the blowing agent is not particularly limited, but is preferably 1 to 50 wt % with respect to the weight of the heat-expandable microspheres. When the encapsulation ratio is in this range, a high internal pressure can be obtained by heating, so that the heat-expandable microspheres can be greatly expanded. The lower limit of the encapsulation ratio of the blowing agent is preferably (1) 3 wt %, (2) 5 wt %, (3) 7 wt %, and (4) 10 wt % in this order (it is more preferable as the number in parentheses increases). On the other hand, the upper limit of the encapsulation ratio is preferably (1) 40 wt %, (2) 33 wt %, (3) 25 wt %, and (4) 20 wt % in this order (it is more preferable as the number in parentheses increases). Further, the encapsulation ratio is, for example, more preferably 3 to 33 wt %, and particularly preferably 10 to 20 wt %.

The mean particle size of the heat-expandable microspheres of the present invention is not particularly limited, but is preferably 0.5 to 100 μm. When the mean particle size is 0.5 μm or more, the expandability of the heat-expandable microspheres tends to be improved. When the mean particle size is 100 μm or less, the expansion stability of the heat-expandable microspheres tends to be improved. The upper limit of the mean particle size is more preferably 80 μm, still more preferably 60 μm, particularly preferably 40 μm, and most preferably 20 μm. The lower limit of the mean particle size is more preferably 1 μm, still more preferably 1.5 μm, particularly preferably 2 μm, and most preferably 5 μm. The mean particle size of the heat-expandable microspheres is determined by the method described in the Examples of the present invention.

A coefficient of variation CV of the particle size distribution of the heat-expandable microspheres is not particularly limited, but is preferably 50% or less, more preferably 45% or less, and particularly preferably 40% or less from the viewpoint of obtaining heat-expandable microspheres having a uniform expansion ratio. Note that the coefficient of variation CV is obtained by the method described in the Examples. The coefficient of variation CV is calculated by the following calculation formulas (1) and (2).

$$[ Mathematical Formula 1 ]$$

$$C V = ( s / < x > ) \times 100 ( \% ) \qquad ( 1 )$$

$$s = {\{ {\sum }_{i = 1}^{n} {( {x}_{i} - < x > )}^{2} / ( n - 1 ) \}}^{1 / 2} \qquad ( 2 )$$

(where s is a standard deviation of the particle size, <x> is the mean particle size, xi is the i-th particle size, and n is the number of particles.)

The volume maximum expansion ratio of the heat-expandable microspheres is not particularly limited, but is preferably 25 times or more, more preferably 30 times or more, still more preferably 40 times or more, particularly preferably 50 times or more, and most preferably 70 times or more from the viewpoint of exhibiting the effect of the present application. On the other hand, the upper limit value of the maximum expansion ratio is preferably 120 times. Note that the maximum expansion ratio of the heat-expandable microspheres is a value obtained by dividing the true specific gravity of the heat-expandable microspheres before thermal expansion by the true specific gravity after maximum expansion.

### [Method for Producing Heat-Expandable Microspheres]

In the heat-expandable microspheres of the present invention, the production method is preferably a method including a step (hereinafter, may be simply referred to as a polymerization step) of dispersing an oily mixture containing the polymerizable component, the blowing agent, and a polymerization initiator in an aqueous dispersion medium to polymerize the polymerizable component.

The polymerization initiator is not particularly limited, and examples thereof include peroxides and azo compounds that are generally used.

Examples of the peroxide include peroxydicarbonates such as diisopropyl peroxydicarbonate, di-sec-butyl peroxydicarbonate, di-2-ethylhexyl peroxydicarbonate, and dibenzyl peroxydicarbonate; diacyl peroxides such as dilauroyl peroxide, di(3,5,5-trimethylhexanoyl) peroxide, and dibenzoyl peroxide; ketone peroxides such as methyl ethyl ketone peroxide and cyclohexanone peroxide; peroxyketals such as 2,2-bis(t-butylperoxy) butane; hydroperoxides such as cumene hydroperoxide and t-butyl hydroperoxide; dialkyl peroxides such as dicumyl peroxide and di-t-butyl peroxide; and peroxyesters such as t-hexylperoxypivalate and t-butylperoxyisobutyrate.

Examples of the azo compound include 2,2′-azobis(4-methoxy-2,4-dimethylvaleronitrile), 2,2′-azobisisobutyronitrile, 2,2′-azobis(2,4-dimethylvaleronitrile), 2,2′-azobis(2-methylpropionate), 2,2′-azobis(2-methylbutyronitrile), and 1,1′-azobis(cyclohexane-1-carbonitrile).

The weight ratio of the polymerization initiator is not particularly limited, but is preferably 0.02 to 12 parts by weight with respect to 100 parts by weight of the polymerizable component. The upper limit of the weight ratio is preferably (1) 10 parts by weight, (2) 8 parts by weight, (3) 5 parts by weight, and (4) 2 parts by weight in this order (it is more preferable as the number in parentheses increases). On the other hand, the lower limit of the weight ratio is preferably (1) 0.05 parts by weight, (2) 0.1 parts by weight, (3) 0.2 parts by weight, and (4) 0.4 parts by weight in this order (it is more preferable as the number in parentheses increases). When the weight ratio is outside the above range, a polymerizable component that is not polymerized remains, and predetermined heat-expandable microspheres may not be stably produced. Further, when the weight ratio exceeds 12 parts by weight, heat resistance may be deteriorated. The polymerization initiator may be used alone or in combination of two or more thereof.

In the polymerization step, the aqueous dispersion medium is a medium for dispersing the oily mixture essentially containing the polymerizable component and the blowing agent, and contains water such as deionized water as a main component. The aqueous dispersion medium may further contain an alcohol such as methanol, ethanol, or propanol, or a hydrophilic organic solvent such as acetone. The hydrophilicity in the present invention means a state of being arbitrarily miscible in water. The amount of the aqueous dispersion medium used is not particularly limited, but it is preferable to use 100 to 1,500 parts by weight of the aqueous dispersion medium with respect to 100 parts by weight of the polymerizable component.

The aqueous dispersion medium may further contain an electrolyte. Examples of the electrolyte include sodium chloride, magnesium chloride, calcium chloride, sodium sulfate, magnesium sulfate, ammonium sulfate, and sodium carbonate. These electrolytes may be used alone or in combination of two or more thereof. The content of the electrolyte is not particularly limited, but is preferably 0 to 50 parts by weight with respect to 100 parts by weight of the aqueous dispersion medium.

The aqueous dispersion medium may contain at least one water-soluble compound selected from water-soluble 1,1-substituted compounds having a structure in which a hydrophilic functional group selected from a hydroxyl group, a carboxylic acid (salt) group, and a phosphonic acid (salt) group and a heteroatom are bonded to the same carbon atom, potassium dichromate, an alkali metal nitrite, a metal (III) halide, boric acid, water-soluble ascorbic acids, water-soluble polyphenols, water-soluble vitamin Bs, and water-soluble phosphonic acids (salts). The term “water-soluble” in the present invention means a state in which 1 g or more is dissolved per 100 g of water.

The amount of the water-soluble compound contained in the aqueous dispersion medium is not particularly limited, but is preferably 0.0001 to 1.0 parts by weight with respect to 100 parts by weight of the polymerizable component. The upper limit of the amount of the water-soluble compound is more preferably 0.5 parts by weight, still more preferably 0.1 parts by weight, and particularly preferably 0.05 parts by weight. On the other hand, the lower limit of the amount of the water-soluble compound is more preferably 0.0003 parts by weight, still more preferably 0.001 parts by weight, and particularly preferably 0.02 parts by weight. When the amount of the water-soluble compound is too small, the effect of the water-soluble compound may not be sufficiently obtained. When the amount of the water-soluble compound is too large, the polymerization rate may decrease, or the residual amount of the polymerizable component as a raw material may increase.

The aqueous dispersion medium may contain a dispersion stabilizer and a dispersion stability auxiliary in addition to the electrolyte and the water-soluble compound.

Examples of the dispersion stabilizer include tricalcium phosphate, magnesium pyrophosphate obtained by a double decomposition production method, calcium pyrophosphate, colloidal silica, alumina sol, and magnesium hydroxide. These dispersion stabilizers may be used alone or in combination of two or more thereof.

The amount of the dispersion stabilizer is not particularly limited, but is preferably 0.05 to 35 parts by weight with respect to 100 parts by weight of the polymerizable component from the viewpoint of obtaining heat-expandable microspheres having a more uniform particle size. The upper limit of the amount of the dispersion stabilizer is more preferably 30 parts by weight, still more preferably 20 parts by weight, and particularly preferably 10 parts by weight. On the other hand, the lower limit of the amount of the dispersion stabilizer is more preferably 0.1 parts by weight, still more preferably 0.2 parts by weight, and particularly preferably 0.5 parts by weight.

The dispersion stability auxiliary is not particularly limited, and examples thereof include a polymer-type dispersion stability auxiliary, and surfactants such as a cationic surfactant, an anionic surfactant, an amphoteric ionic surfactant, and a nonionic surfactant. These dispersion stability auxiliaries may be used alone or in combination of two or more thereof.

The aqueous dispersion medium is prepared, for example, by blending a water-soluble compound together with, as necessary, the dispersion stabilizer and/or the dispersion stability auxiliary and the like in water (deionized water). A pH of the aqueous dispersion medium in the polymerization is appropriately determined depending on the types of the water-soluble compound, the dispersion stabilizer, and the dispersion stability auxiliary.

In the heat-expandable microspheres of the present invention, in the production method thereof, polymerization may be performed in the presence of sodium hydroxide and zinc chloride.

In the heat-expandable microspheres of the present invention, in the production method thereof, it is preferable to suspend and disperse the oily mixture in the aqueous dispersion medium to be formed into spherical oil droplets having a predetermined particle size.

In the polymerization step, a chain transfer agent, organic pigments, inorganic pigments or inorganic particles having a hydrophobically treated surface, or the like may be further used.

In the polymerization step, the oily mixture is suspended and dispersed in the aqueous dispersion medium to be formed into spherical oil droplets having a predetermined particle size.

Examples of the method for suspending and dispersing the oily mixture include general dispersion methods such as a method of stirring with a Homomixer (for example, manufactured by PRIMIX Corporation) or the like, a method using a static dispersion apparatus such as a static mixer (for example, manufactured by NORITAKE CO., LIMITED), a membrane emulsification method, and an ultrasonic dispersion method.

Next, the suspension polymerization is started by heating the aqueous suspension in which the oily mixture is dispersed in the aqueous dispersion medium as spherical oil droplets. During the polymerization reaction, the aqueous suspension is preferably slowly stirred, for example, to such an extent that floating of monomer components and sedimentation of the polymerized heat-expandable microspheres can be prevented.

A polymerization temperature is freely set depending on the type of polymerization initiator, and is preferably controlled in the range of 30 to 100° C., more preferably 40 to 90° C. The time for holding the reaction temperature is preferably about 0.1 to 20 hours. The initial pressure for polymerization is not particularly limited, but is 0 to 5.0 MPa, more preferably 0.1 to 3.0 MPa in gauge pressure.

A cooling temperature for the polymerized reaction solution and the decompression method are not particularly limited, but the reaction solution is preferably cooled to 40° C. or lower before decompression, from the viewpoint of easily obtaining heat-expandable microspheres satisfying the condition 2. More preferably, the reaction solution is cooled to 40° C. or lower, and then the pressure in a compressive reactor is reduced to atmospheric pressure by gradual decompression.

A resulting slurry can be filtered by a centrifuge, a press filter, a suction extractor, or the like to obtain a wet powder having a moisture content of 10 to 50 wt %, preferably 15 to 45 wt %, more preferably 20 to 40 wt %. In addition, the resulting wet powder is dried by a tray dryer, an indirect heating oven, a fluidized bed dryer, a vacuum dryer, a vibration dryer, a flash dryer, or the like to obtain a dry powder. The moisture content of the resulting dry powder is preferably 8 wt % or less, and more preferably 5 wt % or less.

The resulting wet powder or dry powder may be washed with water and/or dispersed again and then filtered again, and dried for the purpose of reducing the content of the ionic substance. The slurry may be dried by a spray dryer, a fluidized bed dryer, or the like to obtain a dry powder. The wet powder and dry powder can be appropriately selected according to the intended use.

### [Fine-Particle-Coated Heat-Expandable Microspheres]

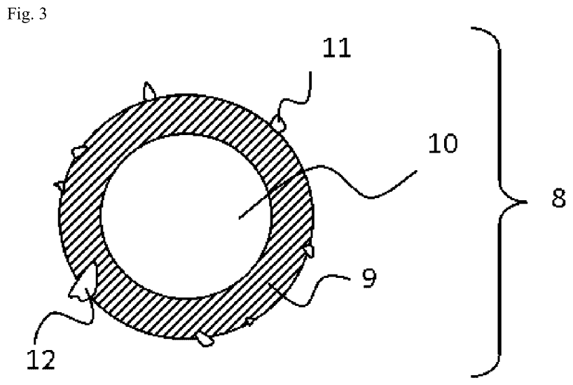

The fine-particle-coated heat-expandable microspheres of the present invention include the heat-expandable microspheres described above and fine particles coating the outer surface of the outer shell portion of the heat-expandable microspheres. The fine-particle-coated heat-expandable microspheres are formed of fine particles (11 and 12) coating the outer surface of an outer shell portion (shell) (9) of heat-expandable microspheres (8) having a blowing agent (core) (10) as illustrated in FIG. 3, for example.

The term “coating” as used herein means that the fine particles 11 and 12 may be simply adsorbed on the outer surface of the outer shell 9 of the heat-expandable microspheres (the state of the fine particles 11 in FIG. 3), or the fine particles may be embedded and fixed on the outer surface of the outer shell of the heat-expandable microspheres (the state of the fine particles 12 in FIG. 3). The particle shape of the fine particles may be irregular or spherical.

The fine-particle-coated heat-expandable microspheres of the present invention can be obtained, for example, by drying the aqueous dispersion containing heat-expandable microspheres and fine particles.

As the fine particles, various materials can be used, and any material of an inorganic substance and an organic substance may be used. Examples of the shape of the fine particles include a spherical shape, a needle shape, and a plate shape.

An inorganic substance constituting the fine particles is not particularly limited, and examples thereof include wollastonite, sericite, kaolin, mica, clay, talc, bentonite, alumina silicate, pyrophyllite, montmorillonite, calcium silicate, calcium carbonate, magnesium carbonate, dolomite, calcium sulfate, barium sulfate, glass flakes, boron nitride, silicon carbide, silica, alumina, mica, titanium dioxide, zinc oxide, magnesium oxide, zinc oxide, hydrotalcite, carbon black, molybdenum disulfide, tungsten disulfide, ceramic beads, glass beads, quartz beads, and glass microballoons.

The organic substance constituting the fine particles is not particularly limited, and examples thereof include sodium carboxymethyl cellulose, hydroxyethyl cellulose, methyl cellulose, ethyl cellulose, nitrocellulose, hydroxypropyl cellulose, sodium alginate, polyvinyl alcohol, polyvinylpyrrolidone, sodium polyacrylate, carboxyvinyl polymer, polyvinyl methyl ether, magnesium stearate, calcium stearate, zinc stearate, polyethylene wax, lauric acid amide, myristic acid amide, palmitic acid amide, stearic acid amide, hydrogenated castor oil, (meth)acrylic resin, polyamide resin, silicone resin, urethane resin, polyethylene resin, polypropylene resin, and fluorine-based resin.

The inorganic substance or the organic substance constituting the fine particles may be treated with a surface treatment agent such as a silane coupling agent, a paraffin wax, a fatty acid, a resin acid, a urethane compound, or a fatty acid ester, or may be untreated.

A mean particle size of the fine particles is not particularly limited, but is preferably 0.001 to 30 μm, more preferably 0.005 to 25 μm, and particularly preferably 0.01 to 20 μm. The mean particle size is a value of the volume-based cumulative 50% particle size measured by laser diffractometry.

The weight ratio of the fine particles in the entire fine-particle-coated heat-expandable microspheres of the present invention is not particularly limited, but is preferably 95 wt % or less, more preferably 90 wt % or less, particularly preferably 85 wt % or less, and most preferably 80 wt % or less from the viewpoint of exhibiting the effect of the present application. When the weight ratio is more than 95 wt %, the weight reduction effect is deteriorated, which may be uneconomical. The lower limit of the weight ratio of the fine particles is preferably 10 wt %, more preferably 20 wt %, particularly preferably 30 wt %, and most preferably 40 wt %.

### [Hollow Particles]

The hollow particles of the present invention are particles obtained by thermally expanding the heat-expandable microspheres described above, and are excellent in material physical properties when contained in a composition or a molded article.

The hollow particles of the present invention are particles obtained by thermally expanding heat-expandable microspheres including an outer shell containing a thermoplastic resin obtained by polymerizing a specific polymerizable component and a blowing agent encapsulated in the outer shell, wherein the temperature at which the derivative thermogravimetric curve measured by the specific method is maximized and the expansion-starting temperature show a specific relationship. Thus, the hollow particles of the present invention can reduce leakage of the blowing agent over time.

The hollow particles of the present invention are obtained by thermally expanding the heat-expandable microspheres described above, preferably at 80 to 300° C. The thermal expansion method is not particularly limited, and may be any of a dry thermal expansion method, a wet thermal expansion method, and the like. Examples of the dry thermal expansion method include a method described in JP 2006-213930 A, the content of which is incorporated herein by reference, particularly an internal injection method. As another dry thermal expansion method, there is a method described in JP 2006-96963 A, the content of which is incorporated herein by reference. Examples of the wet thermal expansion method include a method described in JP 62-201231 A, the content of which is incorporated herein by reference.

A true specific gravity of the hollow particles of the present invention is not particularly limited, but is preferably 0.001 to 0.60. When the true specific gravity is 0.001 or more, the film thickness of the outer shell portion becomes sufficient, and the pressure resistance tends to be improved. On the other hand, when the true specific gravity is 0.60 or less, the effect of reducing the specific gravity is sufficiently obtained, and there is a tendency that physical properties as a composition or a molded article can be sufficiently maintained when the composition is prepared using the hollow particles. The upper limit of the true specific gravity is more preferably 0.50, still more preferably 0.40, particularly preferably 0.30, and most preferably 0.20. On the other hand, the lower limit of the true specific gravity is more preferably 0.003, still more preferably 0.005, particularly preferably 0.007, and most preferably 0.010. The true specific gravity of the hollow particles is measured by the method in the Examples.

### [Fine-Particle-Coated Hollow Particles]

The fine-particle-coated hollow particles of the present invention include the hollow particles described above and fine particles coating the outer surface of the outer shell portion of the hollow particles. The fine-particle-coated hollow particles are formed of fine particles (4 or 5) coating the outer surface of an outer shell portion (2) of hollow particles (1) as illustrated in FIG. 2, for example.

The term “coating” as used herein means that the fine particles 4 and 5 may be simply adsorbed on the outer surface of the outer shell portion 2 of the hollow particles (the state of the fine particles 4 in FIG. 2), or the thermoplastic resin constituting the outer shell in the vicinity of the outer surface is melted by heating, and the fine particles are embedded and fixed on the outer surface of the outer shell of the hollow particles (the state of the fine particles 5 in FIG. 2). The particle shape of the fine particles may be irregular or spherical.

The fine particles coating the hollow particles prevent scattering of the hollow particles to improve handling and dispersibility in a base material component such as a binder or a resin.

As the fine particles constituting the fine-particle-coated hollow particles, the above-described fine particles can be used.

The ratio of the volume-mean particle size of the fine particles to the volume-mean particle size of the hollow particles (volume-mean particle size of fine particles/volume-mean particle size of hollow particles) is not particularly limited, but is preferably 1 or less, more preferably 0.1 or less, and still more preferably 0.05 or less from the viewpoint of sufficiently coating the surface of the hollow particles with the fine particles.

The weight ratio of the fine particles in the entire fine-particle-coated hollow particles is not particularly limited, but is preferably 95 wt % or less, more preferably 90 wt % or less, particularly preferably 85 wt % or less, and most preferably 80 wt % or less. When the weight ratio is more than 95 wt %, the addition amount of the fine-particle-coated hollow particles is increased when a composition is prepared using the fine-particle-coated hollow particles, which may be uneconomical. The lower limit of the weight ratio of the fine particles is preferably 10 wt %, more preferably 20 wt %, particularly preferably 30 wt %, and most preferably 40 wt %.

A true specific gravity of the fine-particle-coated hollow particles is not particularly limited, but is preferably 0.01 to 0.60. When the true specific gravity is 0.01 or more, the film thickness of the outer shell portion becomes sufficient, and deflation tends to be suppressed. On the other hand, when the true specific gravity is 0.60 or less, the effect of reducing the specific gravity is sufficiently obtained, and there is a tendency that physical properties as a composition or a molded article can be sufficiently maintained when a composition is prepared using the fine-particle-coated hollow particles. The upper limit of the true specific gravity is more preferably 0.40, particularly preferably 0.30, and most preferably 0.20. On the other hand, the lower limit of the true specific gravity is more preferably 0.07, and particularly preferably 0.10.

In the fine-particle-coated hollow particles of the present invention, the production method thereof preferably includes, for example, a step of mixing heat-expandable microspheres and fine particles (mixing step), and a step of heating the mixture obtained in the mixing step to a temperature higher than the softening point to expand the heat-expandable microspheres, and coat the outer surface of the obtained hollow particles with the fine particles (coating step). The fine-particle-coated hollow particles can also be obtained by thermally expanding the fine-particle-coated heat-expandable microspheres.

The mixing step is a step of mixing the heat-expandable microspheres and the fine particles.

The weight ratio of the fine particles to the total of the heat-expandable microspheres and the fine particles in the mixing step is not particularly limited, but is preferably 95 wt % or less, more preferably 90 wt % or less, particularly preferably 85 wt % or less, and most preferably 80 wt % or less. When the weight ratio is 95 wt % or less, the resulting fine-particle-coated hollow particles are lightweight, and there is a tendency that a sufficient effect of reducing the specific gravity is obtained. The lower limit of the weight ratio is preferably 5 wt %, more preferably 10 wt %, particularly preferably 20 wt %, and most preferably 30 wt %.

In the mixing step, the apparatus used for mixing the heat-expandable microspheres and the fine particles is not particularly limited, and mixing can be performed using an apparatus having an extremely simple mechanism such as a container and a stirring blade. A powder mixer that can perform general shaking or stirring may also be used.

Examples of the powder mixer include powder mixers that can perform shaking or stirring, such as a ribbon mixer or a vertical screw mixer. In recent years, more efficient multifunctional powder mixers combined with a stirring apparatus, such as Super Mixer (manufactured by KAWATA MFG. CO., LTD.), High Speed Mixer (manufactured by Fukae Co., Ltd.), New-Gra Machine (manufactured by Seishin Enterprise Co., Ltd.), and SV Mixer (manufactured by Kobelco Eco-solutions Co., Ltd.) have been introduced, and these may be used.

The coating step is a step of heating the mixture containing the heat-expandable microspheres and the fine particles obtained in the mixing step to a temperature higher than the softening point of the thermoplastic resin constituting the outer shell of the heat-expandable microspheres. In the coating step, the heat-expandable microspheres are expanded, and the outer surface of the outer shell portion of the obtained hollow particles is coated with the fine particles.

The heat-expandable microspheres may be heated by a common mixer dryer with a contact heating system or a direct heating system. The function of the mixer dryer is not particularly limited, but the mixer dryer preferably has a function of dispersing and mixing raw materials under a controlled temperature, and optionally includes a decompression device for accelerating drying or a cooling device. The device used for heating is not particularly limited, and examples thereof include Loedige Mixer (manufactured by MATSUBO Corporation) and Solidaire (manufactured by Hosokawa Micron Corporation).

The temperature condition of heating depends on the type of the heat-expandable microspheres, but the heating temperature is preferably set to the optimum expansion temperature. The temperature is preferably 70 to 250° C., more preferably 80 to 210° C., and still more preferably 90 to 170° C.

### [Composition and Molded Article]

The composition of the present invention contains at least one selected from the heat-expandable microspheres, the fine-particle-coated heat-expandable microspheres, the hollow particles, and the fine-particle-coated hollow particles described above, and a base material component.

The base material component is not particularly limited, and examples thereof include rubbers such as natural rubber, butyl rubber, silicone rubber, and ethylene-propylene-diene rubber (EPDM); thermosetting resins such as unsaturated polyester, epoxy resin, and phenol resin; waxes such as polyethylene wax and paraffin wax; thermoplastic resins such as ethylene-vinyl acetate copolymer (EVA), ionomer, polyethylene, polypropylene, polyvinyl chloride (PVC), acrylic resin, thermoplastic polyurethane, acrylonitrile-styrene copolymer (AS resin), acrylonitrile-butadiene-styrene copolymer (ABS resin), polystyrene (PS), polyamide resin (Nylon 6, Nylon 66, and the like), polycarbonate, polyethylene terephthalate (PET), polybutylene terephthalate (PBT), polyacetal (POM), and polyphenylene sulfide (PPS); thermoplastic elastomers such as olefin-based elastomers and styrene-based elastomers; fluorine-containing resins such as polyvinylidene fluoride, polytetrafluoroethylene, vinylidene fluoride-hexafluoropropylene-tetrafluoroethylene copolymer, vinylidene fluoride-hexafluoropropylene copolymer, vinylidene fluoride-tetrafluoroethylene copolymer, hexafluoropropylene-tetrafluoroethylene copolymer, and ethylene-tetrafluoroethylene; bioplastics such as polylactic acid (PLA), cellulose acetate, PBS, PHA, and starch resin; sealing materials such as silicone-based, modified silicone-based, polysulfide-based, modified polysulfide-based, urethane-based, acryl-based, polyisobutylene-based, and butyl rubber-based sealing materials; liquid components such as urethane-based, ethylene-vinyl acetate copolymer-based, vinyl chloride-based, and acryl-based emulsions and plastisols; water-soluble polymers such as polyethylene glycol, polyglycerin, polyacrylic acid, polyacrylate, polyvinyl alcohol, hydroxypropyl methylcellulose, and methyl cellulose; inorganic substances such as cement, mortar, and cordierite; and organic fibers such as cellulose, kenaf, bran, aramid fibers, phenol fibers, polyester-based fibers, acrylic fibers, polyolefin-based fibers including polyethylene fibers and polypropylene fibers, polyvinyl alcohol-based fibers, and rayon. These base material components may be diluted, dissolved, and dispersed in water or an organic solvent. These base material components may be used alone or in combination of two or more thereof.

The composition of the present invention can be prepared by mixing at least one selected from the heat-expandable microspheres, the fine-particle-coated heat-expandable microspheres, the hollow particles, and the fine-particle-coated hollow particles with the base material component. The composition of the present invention can also be prepared by further mixing another base material component with the composition obtained by mixing at least one selected from the heat-expandable microspheres, the fine-particle-coated heat-expandable microspheres, the hollow particles, and the fine-particle-coated hollow particles with the base material component.

The composition of the present invention may also contain at least one selected from the heat-expandable microspheres, the fine-particle-coated heat-expandable microspheres, the hollow particles, and the fine-particle-coated hollow particles, and other components as appropriate depending on the application in addition to the base material component. Examples of the other components include a plasticizer, a filler, a colorant, a high-boiling-point organic solvent, an adhesive, and a viscosity modifier.

In the composition of the present invention, the total content of the heat-expandable microspheres, the fine-particle-coated heat-expandable microspheres, the hollow particles, and the fine-particle-coated hollow particles is not particularly limited, but is preferably 0.05 to 750 parts by weight with respect to 100 parts by weight of the base material component. When the total content is 0.05 parts by weight or more, a sufficiently lightweight molded article tends to be obtained. On the other hand, when the total content is 750 parts by weight or less, the uniform dispersibility of at least one selected from the heat-expandable microspheres, the fine-particle-coated heat-expandable microspheres, the hollow particles, and the fine-particle-coated hollow particles tends to be further improved. The upper limit of the total content is more preferably 700 parts by weight, still more preferably 600 parts by weight, particularly preferably 500 parts by weight, and most preferably 400 parts by weight. On the other hand, the lower limit of the total content is more preferably 0.1 parts by weight, still more preferably 0.2 parts by weight, particularly preferably 0.5 parts by weight, and most preferably 1 part by weight.

The method for preparing the composition of the present invention is not particularly limited, and conventionally known methods may be employed. Examples of the method include a method of mechanically uniformly mixing using a mixer such as a Homomixer, a static mixer, a Henschel mixer, a tumbler mixer, a planetary mixer, a kneader, a roll, a mixing roll, a mixer, a single screw kneader, a twin screw kneader, or a multi-screw kneader.

Examples of the composition of the present invention include a rubber composition, a molding composition, a coating composition, a clay composition, an adhesive composition, and a powder composition.

The molded article of the present invention is obtained by molding the composition described above.

Examples of the molded article of the present invention include molded articles and coating films.

In the molded article of the present invention, various physical properties such as lightweight, porosity, sound absorption, heat insulation, low thermal conductivity, low dielectric constant, designability, impact absorption, and strength are improved, and an effect of excellent appearance can also be obtained.

### EXAMPLES

Hereinafter, Examples of the heat-expandable microspheres of the present invention will be specifically described. Note that the present invention is not limited to these Examples. In the following Examples and Comparative Examples, unless otherwise specified, “%” means “wt %”, and “parts” means “parts by weight”. In addition, the physical properties of the heat-expandable microspheres described in the following Examples and Comparative Examples were measured in the following manner, and the performance was further evaluated. Hereinafter, the heat-expandable microspheres may be referred to as “microspheres” for the sake of simplicity.

### [Mean Particle Size (D50) of Heat-Expandable Microspheres]

As a measuring instrument, a Microtrac particle size distribution analyzer (model: 9320-HRA) manufactured by Nikkiso Co., Ltd. was used, and a D50 value obtained by volume-based measurement was defined as a mean particle size.

### [Measurement of Expansion-Starting Temperature (Ts(° C.)) and Maximum Expansion Temperature (Tm(° C.)) of Heat-Expandable Microspheres]

DMA (DMA Q800 type, manufactured by TA instruments) was used as a measuring instrument. In an aluminum cup having a diameter of 6.0 mm (inner diameter: 5.65 mm) and a depth of 4.8 mm, 0.5 mg of microspheres were placed, and an aluminum lid (diameter: 5.6 mm, thickness: 0.1 mm) was placed on the layer of the microspheres to prepare a sample. The height of the sample was measured while applying a force of 0.01 N to the sample from above with a compression unit. The sample was heated from 20° C. to 300° C. at a temperature rising rate of 10° C./min while applying a force of 0.01 N with the compression unit, and the change in the position of the compression unit in the vertical direction was measured. The temperature at which the position of the compression unit started to change to the positive direction was defined as an expansion-starting temperature (Ts(° C.)), and the temperature at which change in the position of the compression unit indicated the maximum (Hₘₐₓ) was defined as a maximum expansion temperature (Tm(° C.)).

[Measurement of Temperature Td(° C.) at which DTG Value is Maximized in Derivative Thermogravimetric Curve (DTG)]

A thermogravimetric analyzer (TGA Q500 manufactured by TA Instruments) was used as a measuring instrument. In a 500 μL ceramic pan, 0.001 g of microspheres as a sample were placed, and heated from 20° C. to 300° C. at a temperature rising rate of 10° C./min in a nitrogen atmosphere. The weight loss of the sample during heating was measured to obtain a thermogravimetric weight loss curve. A derivative thermogravimetric curve (DTG) was obtained by differentiating the obtained thermogravimetric weight loss curve with respect to time. The temperature of the sample at which the obtained derivative thermogravimetric curve reached the maximum value was defined as the temperature at which the DTG value was maximized (Td(° C.)).

### [Measurement of Moisture Content (C_{w1}) of Heat-Expandable Microspheres]

Measurement was performed using a Karl Fischer moisture meter (MKA-510N, manufactured by Kyoto Electronics Manufacturing Co., Ltd.) as a measuring instrument. The moisture content (wt %) of the heat-expandable microspheres was defined as C_{w1}(%).

### [Measurement of Encapsulation Ratio (C₁) of Blowing Agent of Heat-Expandable Microspheres]

In a stainless steel evaporating dish having a diameter of 80 mm and a depth of 15 mm, 1.0 g of heat-expandable microspheres were placed, and the weight (W₁ (g)) thereof was measured. Then, 30 ml of acetonitrile was added to disperse the microspheres uniformly, the resulting dispersion was allowed to stand at room temperature for 24 hours, and then dried under reduced pressure at 130° C. for 2 hours, and the weight (W₂ (g)) of the resultant was measured.

The encapsulation ratio (C₁) of the blowing agent of the heat-expandable microspheres was calculated by the following formula.

$${C}_{1} ( wt \% ) = 100 \times \{ 100 \times ( {W}_{1} - {W}_{2} ) / 1. - {C}_{w 1} \} / ( 100 - {C}_{w 1} )$$

(where the moisture content C_{w1} of the heat-expandable microspheres was measured by the above method.)

### [Measurement of True Specific Gravity]

The true specific gravity of the heat-expandable microspheres, the hollow particles, or the fine-particle-coated hollow particles (hereinafter, may be simply referred to as sample particles in general) was measured by the following measurement method.

The true specific gravity was measured by a liquid immersion method (Archimedes method) using isopropyl alcohol under an atmosphere of an environmental temperature of 25° C. and a relative humidity of 50%.

Specifically, a 100-mL measuring flask was emptied and dried, and then the weight (WB1) of the measuring flask was weighed. The weighed measuring flask was filled with isopropyl alcohol accurately to form meniscus, and then the weight (WB2) of the measuring flask filled with 100 mL of isopropyl alcohol was weighed. The 100-mL measuring flask was emptied and dried, and then the weight (WS1) of the measuring flask was weighed. The weighed measuring flask was filled with about 50 mL of sample particles, and the weight (WS2) of the measuring flask filled with the sample particles was weighed. Then, isopropyl alcohol was poured into the measuring flask filled with the sample particles accurately to form meniscus so that bubbles did not enter, and then the weight (WS3) of the measuring flask filled with the particles and isopropyl alcohol was weighed. Then, the obtained WB1, WB2, WS1, WS2, and WS3 were introduced into the following formula to calculate the true specific gravity (d) of the sample particles.

$$d = \{ ( WS 2 - WS 1 ) \times ( WB 2 - WB 1 ) / 100 \} / \{ ( WB 2 - WB 1 ) - ( WS 3 - WS 2 ) \}$$

[Measurement of True Specific Gravity of Heat-Expandable Microspheres after Expansion]

A flat-bottomed box having a length of 12 cm, a width of 13 cm, and a height of 9 cm was made with aluminum foil, 1.0 g of the heat-expandable microspheres were uniformly placed in the box, and the box was covered with aluminum foil. The box covered with aluminum foil was placed in a gear-type oven and heated at the maximum expansion temperature of the heat-expandable microspheres described above for 2 minutes to obtain expanded microspheres. The true specific gravity of the obtained hollow particles as expanded microspheres was measured by the method described above.

### [Evaluation of Leakage Reduction of Blowing Agent Over Time]

The heat-expandable microspheres were heated at the maximum expansion temperature Tm(° C.) for 2 minutes to obtain expanded microspheres. Then, 1 g of the obtained hollow particles as the expanded microspheres were placed in an aluminum cup, and subjected to a constant temperature and humidity treatment under the following conditions A (room temperature) and B (high temperature) using SH-241 manufactured by ESPEC Corporation. The encapsulation ratio of the blowing agent in each of the hollow particles before the constant temperature and humidity treatment and the hollow particles after the constant temperature and humidity treatment was measured by the method described above, and the measured values were respectively defined as the encapsulation ratio (C₂) before the constant temperature and humidity treatment, and the encapsulation ratio (C₃) after the constant temperature and humidity treatment. The obtained encapsulation ratio (C₂) before the constant temperature and humidity treatment and encapsulation ratio (C₃) after the constant temperature and humidity treatment were introduced into the following formula to calculate the retention rate of the blowing agent, and the leakage reduction of the blowing agent over time was evaluated according to the following criteria.

$$Retention rate of blowing agent ( \% ) = {C}_{3} / {C}_{2} \times 100$$

### Condition a (Room Temperature)

Temperature: 25° C.
Humidity: 65% RH
Time: 72 hours

### Condition B (High Temperature)

Temperature: 60° C.
Humidity: 85% RH
Time: 72 hours

A: The retention rate of the blowing agent is 90% or more and 100% or less, and the leakage reduction of the blowing agent over time is excellent.

B: The retention rate of the blowing agent is 80% or more and less than 90%, and the leakage reduction of the blowing agent over time is slightly excellent.

C: The retention rate of the blowing agent is 70% or more and less than 80%, and the leakage reduction of the blowing agent over time is slightly poor.

D: The retention rate of the blowing agent is 0% or more and less than 70%, and the leakage reduction of the blowing agent over time is poor.

### Example 1

To 500 parts of deionized water, 1.0 parts of polyvinylpyrrolidone, 0.05 parts of carboxymethylated polyethyleneimine Na salt, and 65 parts of colloidal silica (effective concentration: 20%) were added, and the pH of the mixture was adjusted to 3.0 to prepare an aqueous dispersion medium.

Separately, 175 parts of acrylonitrile, 13 parts of methyl methacrylate, 112 parts of vinylidene chloride, 0.8 parts of ethylene glycol dimethacrylate, 41 parts of isobutane, 2 parts of di-2-ethylhexyl peroxydicarbonate (purity: 70%), and 1 part of diisopropyl peroxydicarbonate were mixed to obtain an oily mixture.

The aqueous dispersion medium and the oily mixture were mixed, and the obtained mixed liquid was stirred with a Homomixer (manufactured by PRIMIX Corporation) for dispersion at a rotation speed of 10,000 rpm until the droplet size of the oily mixture reached the target size of the heat-expandable microspheres, thereby preparing an aqueous suspension.

The obtained aqueous suspension was transferred to a 1.5-L compressive reactor, the reactor was purged with nitrogen, and the suspension was subjected to a polymerization reaction at a polymerization temperature of 60° C. for 20 hours with stirring at 80 rpm under an initial reaction pressure of 0.5 MPa. After the polymerization, the reaction solution was cooled to 40° C. or lower, and then the pressure in the compressive reactor was reduced to atmospheric pressure by gradual decompression, thereby obtaining a dispersion containing a product. The dispersion containing the product was filtered to obtain the product, and the product was dried to obtain heat-expandable microspheres. The physical properties of the obtained heat-expandable microspheres were measured and evaluated. The results are shown in Table 1.

In Table 1 and Tables 2 to 4 shown below, the abbreviations shown in Table 5 are used.

### Examples 2 to 17

In Examples 2 to 17, heat-expandable microspheres of Examples 2 to 17 were obtained in the same manner as in Example 1 except that in Example 1, the conditions were changed as shown in Tables 1 and 2.

### Comparative Example 1

To 500 parts of deionized water, 1.0 parts of polyvinylpyrrolidone, 0.05 parts of carboxymethylated polyethyleneimine Na salt, and 65 parts of colloidal silica (effective concentration: 20%) were added, and the pH of the mixture was adjusted to 3.0 to prepare an aqueous dispersion medium.

Separately, 90 parts of acrylonitrile, 15 parts of methyl methacrylate, 195 parts of vinylidene chloride, 4.7 parts of diethylene glycol dimethacrylate, 48 parts of isobutane, and 3 parts of diisopropyl peroxydicarbonate were mixed to obtain an oily mixture.

The aqueous dispersion medium and the oily mixture were mixed, and the obtained mixed liquid was stirred with a Homomixer (manufactured by PRIMIX Corporation) for dispersion at a rotation speed of 10,000 rpm until the droplet size of the oily mixture reached the target size of the heat-expandable microspheres, thereby preparing an aqueous suspension.

The obtained aqueous suspension was transferred to a 1.5-L compressive reactor, the reactor was purged with nitrogen, and the suspension was subjected to a polymerization reaction at a polymerization temperature of 60° C. for 20 hours with stirring at 80 rpm under an initial reaction pressure of 0.35 MPa. After the polymerization, the reaction solution was cooled to 50° C., and then the pressure in the compressive reactor was reduced to atmospheric pressure by decompression, thereby obtaining a dispersion containing a product. The dispersion containing the product was filtered to obtain the product, and the product was dried to obtain heat-expandable microspheres. The physical properties of the obtained heat-expandable microspheres were measured and evaluated in the same manner as in Example 1. The results are shown in Table 3.

### Comparative Examples 2 to 16

In Comparative Examples 2 to 16, heat-expandable microspheres of Comparative Examples 2 to 13 were obtained in the same manner as in Comparative Example 1 except that in Comparative Example 1, the conditions were changed as shown in Tables 3 and 4.

The physical properties of each of the obtained heat-expandable microspheres were measured and evaluated in the same manner as in Example 1. The results are shown in Tables 3 and 4.

### Example 18

The heat-expandable microspheres obtained in Example 15 were heated at 120° C. for 5 minutes to obtain hollow particles having a true specific gravity of 0.02. Then, 70 parts by weight of the obtained hollow particles, 200 parts by weight of polyvinyl alcohol, 800 parts by weight of vinyl acetate, 20 parts by weight of boric acid and 1,000 parts by weight of water were blended, and mixed for 10 minutes with a universal mixer to obtain a clay composition. The obtained clay composition was lightweight, had little surface irregularities, and had a good appearance.

### Example 19

A clay composition was obtained in the same manner as in Example 18 except that in Example 18, the heat-expandable microspheres to be used were changed to the heat-expandable microspheres obtained in Example 12. At this time, the true specific gravity of the obtained hollow particles was 0.015. The obtained clay composition was lightweight, had little surface irregularities, and had a good appearance.

### Example 20

In water, 100 parts by weight of the heat-expandable microspheres obtained in Example 15 and 10 parts by weight of silica were dispersed, and the resulting dispersion was dried at 70° C. with a mixer dryer to obtain fine-particle-coated heat-expandable microspheres. The obtained fine-particle-coated heat-expandable microspheres were heated at 120° C. for 5 minutes to obtain fine-particle-coated hollow particles having a true specific gravity of 0.03. Then, 1 part by weight of the fine-particle-coated hollow particles were mixed with a vinyl chloride resin binder prepared by mixing 100 parts by weight of a PVC paste (PCH-175, manufactured by KANEKA CORPORATION), 100 parts by weight of DINP (SANSO CIZER manufactured by New Japan Chemical Co., Ltd.), and 200 parts by weight of calcium carbonate (Whiten red manufactured by Bihoku Funka Kogyo Co., Ltd.) to prepare a vinyl chloride resin coating composition. The prepared coating composition was applied to a plate coated with electrodeposition (thickness: 2 mm), and heated at 140° C. for 20 minutes to obtain a molded article. The obtained molded article was lightweight, had little surface irregularities, and had a good appearance.

### Example 21

A coating composition and a molded article were obtained in the same manner as in Example 20 except that in Example 20, the heat-expandable microspheres to be used were changed to the heat-expandable microspheres obtained in Example 12. The true specific gravity of the fine-particle-coated hollow particles obtained at this time was 0.025. The obtained molded article was lightweight, had little surface irregularities, and had a good appearance.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Monomer (A) | VCl₂ | | 112 | 80 | 94 | 119 | 109 | 90 | 104 | 68 | 106 |
| Monomer (B) | AN | | 175 | 209 | 160 | 136 | 120 | 130 | 151 | 171 | 148 |
| Another | MMA | | 13 | 11 | 46 | 45 | 71 | 49 | 45 | | 46 |
| monomer (C) | MAN | | | | | | | 31 | | | |
| | MA | | | | | | | | | 61 | |
| | EA | | | | | | | | | | |
| | BA | | | | | | | | | | |
| | MAA | | | | | | | | | | |
| | AAm | | | | | | | | | | |
| Cross- | Cross-linking agent A | | | | 0.9 | | | 0.9 | | 0.4 | 0.5 |
| linking agent | Cross-linking agent B | | | 0.6 | 0.4 | | | | | 0.2 | 0.2 |
| | Cross-linking agent C | | | 0.6 | | | 0.9 | | 0.7 | | |
| | Cross-linking agent D | | 0.8 | | | 0.6 | 0.9 | | 0.7 | 0.2 | |
| | Cross-linking agent E | | | | | | | | | | |
| Blowing agent | iC4 | | 41 | 38 | 56 | 20 | 43 | 40 | 53 | 35 | 50 |
| | iC5 | | | | | 10 | | | | | |
| | iC8 | | | | | | | | | | |
| Polymerization | Initiator A | | 2 | 2 | 2.5 | 2.5 | 1.5 | 2 | 1.5 | 1 | 1.5 |
| initiator | Initiator B | | | 1 | | 1.5 | 2 | | 2.5 | 1 | |
| | Initiator C | | 1 | | | | | | | | |
| | Initiator D | | | | | | | | | | |
| Weight ratio of monomer (A) (%) | | | 37.3 | 26.7 | 31.3 | 39.7 | 36.3 | 30.0 | 34.7 | 22.7 | 35.3 |
| Weight ratio of monomer (B) (%) | | | 58.3 | 69.7 | 53.3 | 45.3 | 40.0 | 43.3 | 50.3 | 57.0 | 49.3 |
| Weight ratio of (meth)acrylic acid ester (%) | | | 4.3 | 3.7 | 15.3 | 15.0 | 23.7 | 16.3 | 15.0 | 20.3 | 15.3 |
| Weight ratio of monomer (B)/weight ratio of | | | 1.56 | 2.61 | 1.70 | 1.14 | 1.10 | 1.44 | 1.45 | 2.51 | 1.40 |
| monomer (A) | | | | | | | | | | | |
| Total weight ratio of monomer (C)/weight | | | 11.6 | 13.8 | 48.9 | 37.8 | 65.1 | 88.9 | 43.3 | 89.7 | 43.4 |
| ratio of monomer (A) (%) | | | | | | | | | | | |
| Total weight ratio of monomer (A) and | | | 95.7 | 96.3 | 84.7 | 85.0 | 76.3 | 73.3 | 85.0 | 79.7 | 84.7 |
| monomer (B) (%) | | | | | | | | | | | |
| Physical | Ts (° C.) | | 96 | 115 | 93 | 96 | 93 | 102 | 102 | 91 | 87 |
| properties of | Tm (° C.) | | 121 | 139 | 148 | 134 | 131 | 139 | 140 | 148 | 126 |
| heat- | Td (° C.) | | 129 | 148 | 160 | 140 | 149 | 151 | 150 | 160 | 137 |
| expandable | Td − Ts (° C.) | | 33 | 33 | 67 | 44 | 56 | 49 | 48 | 69 | 50 |
| microspheres | Mean particle size (μm) | | 9 | 15 | 15 | 6 | 11 | 13 | 13 | 16 | 10 |
| | Encapsulation ratio (%) | | 11.3 | 10.5 | 15.0 | 8.4 | 11.6 | 11.1 | 14.2 | 9.7 | 13.5 |
| | Specific gravity at | | 0.03 | 0.035 | 0.03 | 0.03 | 0.03 | 0.02 | 0.03 | 0.02 | 0.015 |
| | maximum expansion (g/ml) | | | | | | | | | | |
| | Retention | Condition A (room | 92 | 95 | 99 | 96 | 97 | 89 | 98 | 87 | 97 |
| | rate of | temperature) (%) | | | | | | | | | |
| | blowing | Leakage reduction | A | A | A | A | A | B | A | B | A |
| | agent | of blowing agent | | | | | | | | | |
| | | at normal temperature | | | | | | | | | |
| | | Condition B (high | 88 | 91 | 97 | 92 | 95 | 85 | 96 | 83 | 96 |
| | | temperature) (%) | | | | | | | | | |
| | | Leakage reduction | B | A | A | A | A | B | A | B | A |
| | | of blowing agent | | | | | | | | | |
| | | at high temperature | | | | | | | | | |

TABLE 2

| | | | Example | | | | | | | |
|---|---|---|---|---|---|---|---|---|---|---|
| | | | 10 | 11 | 12 | 13 | 14 | 15 | 16 | 17 |
| Monomer (A) | VCl₂ | | 123 | 113 | 119 | 109 | 30 | 46 | 87 | 120 |
| Monomer (B) | AN | | 129 | 139 | 136 | 120 | 148 | 148 | 156 | 141 |
| Another | MMA | | 38 | 38 | 45 | 71 | 46 | 46 | 57 | 39 |
| monomer (C) | MAN | | 10 | | | | | | | |
| | MA | | | 10 | | | | | | |
| | EA | | | | | | 76 | | | |
| | BA | | | | | | | 60 | | |
| | MAA | | | | | | | | | |
| | AAm | | | | | | | | | |
| Cross- | Cross-linking agent A | | 0.7 | 1 | | | | | 0.4 | 0.7 |
| linking agent | Cross-linking agent B | | | | | | 0.9 | 0.7 | | |
| | Cross-linking agent C | | | | 0.2 | 0.8 | | 0.4 | 0.4 | |
| | Cross-linking agent D | | 0.6 | | 0.2 | | | | 0.7 | 0.7 |
| | Cross-linking agent E | | | | | | | | | |
| Blowing agent | iC4 | | 45 | 45 | 45 | 43 | 50 | 50 | 55 | 45 |
| | iC5 | | | | | | | | | |
| | iC8 | | | | | | | | | 10 |
| Polymerization | Initiator A | | 3 | 3 | 2.5 | 2 | 1.5 | 1.5 | 4 | 2.5 |
| initiator | Initiator B | | 1 | 1 | 1.5 | 2 | | | 4 | 1.5 |
| | Initiator C | | | | | | | | | |
| | Initiator D | | | | | | | | | |
| Weight ratio of monomer (A) (%) | | | 41.0 | 37.7 | 39.7 | 36.3 | 10.0 | 15.3 | 29.0 | 40.0 |
| Weight ratio of monomer (B) (%) | | | 43.0 | 46.3 | 45.3 | 40.0 | 49.3 | 49.3 | 52.0 | 47.0 |
| Weight ratio of (meth)acrylic acid ester (%) | | | 12.7 | 16.0 | 15.0 | 23.7 | 40.7 | 35.3 | 19.0 | 13.0 |
| Weight ratio of monomer (B)/weight ratio of | | | 1.05 | 1.23 | 1.14 | 1.10 | 4.93 | 3.22 | 1.79 | 1.18 |
| monomer (A) | | | | | | | | | | |
| Total weight ratio of monomer (C)/weight | | | 39.0 | 42.5 | 37.8 | 65.1 | 406.7 | 230.4 | 65.5 | 32.5 |
| ratio of monomer (A) (%) | | | | | | | | | | |
| Total weight ratio of monomer (A) and | | | 84.0 | 84.0 | 85.0 | 76.3 | 59.3 | 64.7 | 81.0 | 87.0 |
| monomer (B) (%) | | | | | | | | | | |
| Physical | Ts (° C.) | | 92 | 94 | 96 | 91 | 86 | 85 | 100 | 90 |
| properties of | Tm (° C.) | | 120 | 123 | 134 | 129 | 129 | 113 | 135 | 133 |
| heat- | Td (° C.) | | 130 | 131 | 140 | 147 | 136 | 120 | 141 | 135 |
| expandable | Td − Ts (° C.) | | 38 | 37 | 44 | 56 | 50 | 35 | 41 | 45 |
| microspheres | Mean particle size (μm) | | 13 | 10 | 8 | 11 | 10 | 10 | 11 | 10 |
| | Encapsulation ratio (%) | | 12.1 | 12.2 | 12.2 | 11.8 | 13.5 | 13.5 | 14.2 | 15.0 |
| | Specific gravity at maximum | | 0.02 | 0.03 | 0.015 | 0.03 | 0.02 | 0.02 | 0.02 | 0.025 |
| | expansion (g/ml) | | | | | | | | | |
| | Retention | Condition A (room | 96 | 90 | 96 | 88 | 83 | 85 | 98 | 95 |
| | rate of | temperature) (%) | | | | | | | | |
| | blowing | Leakage reduction of | A | A | A | B | B | B | A | A |
| | agent | blowing agent at | | | | | | | | |
| | | normal temperature | | | | | | | | |
| | | Condition B (high | 93 | 86 | 94 | 84 | 80 | 81 | 97 | 93 |
| | | temperature)(%) | | | | | | | | |
| | | Leakage reduction of | A | B | A | B | B | B | A | A |
| | | blowing agent at high | | | | | | | | |
| | | temperature | | | | | | | | |

TABLE 3

| | | | Comparative Example | | | | | | | |
|---|---|---|---|---|---|---|---|---|---|---|
| | | | 1 | 2 | 3 | 4 | 5 | 6 | 7 | 8 |
| Monomer (A) | VCl₂ | | 195 | 150 | 108 | 135 | 140 | 90 | 48 | 182 |
| Monomer (B) | AN | | 90 | 99 | 165 | 135 | 140 | 210 | 48 | 102 |
| Another | MMA | | 15 | 51 | 27 | 30 | 20 | | 60 | 16 |
| monomer (C) | MAN | | | | | | | | 48 | |
| | MA | | | | | | | | | |
| | EA | | | | | | | | | |
| | BA | | | | | | | | | |
| | MAA | | | | | | | | 60 | |
| | AAm | | | | | | | | 36 | |
| Cross- | Cross-linking agent A | | | | | | | | | |
| linking agent | Cross-linking agent B | | 4.7 | | | 0.5 | | | | |
| | Cross-linking agent C | | | | | | | | | |
| | Cross-linking agent D | | | | | | 1.5 | | | 1.2 |
| | Cross-linking agent E | | | 0.6 | 0.6 | 0.5 | | | 7.2 | |
| Blowing agent | iC4 | | 48 | 45 | 56 | 70 | 75 | | | 53 |
| | iC5 | | | | | | | 90 | 55 | |
| | iC8 | | | | | | | | 5 | |
| Polymerization | Initiator A | | | 3.4 | 3.4 | 3 | | | | 3 |
| initiator | Initiator B | | | | | | | | | |
| | Initiator C | | 3 | | | | 1 | | 2 | |
| | Initiator D | | | | | | | 3 | 2 | 0.5 |
| Weight ratio of monomer (A) (%) | | | 65.0 | 50.0 | 36.0 | 45.0 | 46.7 | 30.0 | 16.0 | 60.7 |
| Weight ratio of monomer (B) (%) | | | 30.0 | 33.0 | 55.0 | 45.0 | 46.7 | 70.0 | 16.0 | 34.0 |
| Weight ratio of (meth)acrylic acid ester (%) | | | 5.0 | 17.0 | 9.0 | 10.0 | 6.7 | 0.0 | 20.0 | 5.3 |
| Weight ratio of monomer (B)/weight ratio of | | | 0.46 | 0.66 | 1.53 | 1.00 | 1.00 | 2.33 | 1.00 | 0.56 |
| monomer (A) | | | | | | | | | | |
| Total weight ratio of monomer (C)/weight | | | 7.7 | 34.0 | 25.0 | 22.2 | 14.3 | 0.0 | 425.0 | 8.8 |
| ratio of monomer (A) (%) | | | | | | | | | | |
| Total weight ratio of monomer (A) and | | | 95.0 | 83.0 | 91.0 | 90.0 | 93.3 | 100.0 | 32.0 | 94.7 |
| monomer (B) (%) | | | | | | | | | | |
| Physical | Ts (° C.) | | 75 | 89 | 109 | 85 | 81 | 85 | 152 | 75 |
| properties | Tm (° C.) | | 95 | 116 | 126 | 115 | 107 | 110 | 222 | 118 |
| of heat- | Td (° C.) | | 104 | 122 | 136 | 89 | 117 | 113 | 233 | 83 |
| expandable | Td − Ts (° C.) | | 29 | 33 | 27 | 4 | 36 | 28 | 81 | 8 |
| microspheres | Mean particle size (μm) | | 15 | 12 | 7 | 4.5 | 12 | 11 | 25 | 15 |
| | Encapsulation ratio (%) | | 12.8 | 11.8 | 14.1 | 18.1 | 19.5 | 22.4 | 15.7 | 14.1 |
| | Specific gravity at maximum | | 0.06 | 0.014 | 0.05 | 0.05 | 0.05 | 0.04 | 0.08 | 0.04 |
| | expansion (g/ml) | | | | | | | | | |
| | Retention | Condition A (room | 56 | 68 | 78 | 67 | 79 | 61 | 70 | 41 |
| | rate of | temperature) (%) | | | | | | | | |
| | blowing | Leakage reduction | D | D | C | D | C | D | C | D |
| | agent | of blowing agent at | | | | | | | | |
| | | normal temperature | | | | | | | | |
| | | Condition B (high | 28 | 44 | 76 | 42 | 75 | 33 | 48 | 19 |
| | | temperature) (%) | | | | | | | | |
| | | Leakage reduction | D | D | C | D | C | D | D | D |
| | | of blowing agent at | | | | | | | | |
| | | high temperature | | | | | | | | |

TABLE 4

| | | | Comparative Example | | | | | | | |
|---|---|---|---|---|---|---|---|---|---|---|
| | | | 9 | 10 | 11 | 12 | 13 | 14 | 15 | 16 |
| Monomer (A) | VCl₂ | | 145 | 140 | 140 | | 130 | | 127 | 113 |
| Monomer (B) | AN | | 135 | 120 | | 134 | 120 | 139 | 125 | 139 |
| Another monomer | MMA | | 20 | 30 | 40 | 37 | 50 | 151 | 38 | 38 |
| (C) | MAN | | | 10 | 120 | | | | | |
| | MA | | | | | 129 | | 10 | 10 | 10 |
| | EA | | | | | | | | | |
| | BA | | | | | | | | | |
| | MAA | | | | | | | | | |
| | AAm | | | | | | | | | |
| Cross-linking | Cross-linking agent A | | | | | 0.5 | | 1 | 1 | 1 |
| agent | Cross-linking agent B | | | | | 0.3 | 0.7 | | | |
| | Cross-linking agent C | | | | 0.5 | | 0.5 | | | |
| | Cross-linking agent D | | | 2 | 0.5 | | | | | |
| | Cross-linking agent E | | 1.5 | | | 0.2 | | | | |
| Blowing agent | iC4 | | 53 | 70 | 49 | 37 | 26 | 45 | 45 | 55 |
| | iC5 | | | | | | 23 | | | |
| | iC8 | | | | | | | | | |
| Polymerization | Initiator A | | 3 | 3 | 3 | 3 | 3 | 3 | 3 | 3 |
| initiator | Initiator B | | | | | | | 1 | 1 | 1 |
| | Initiator C | | | | | | | | | |
| | Initiator D | | | | | | | | | |
| Weight ratio of monomer (A) (%) | | | 48.3 | 46.7 | 46.7 | 0.0 | 43.3 | 0.0 | 42.3 | 37.7 |
| Weight ratio of monomer (B) (%) | | | 45.0 | 40.0 | 0.0 | 44.7 | 40.0 | 46.3 | 41.7 | 46.3 |
| Weight ratio of (meth)acrylic acid ester (%) | | | 6.7 | 10.0 | 13.3 | 55.3 | 16.7 | 53.7 | 16.0 | 16.0 |
| Weight ratio of monomer (B)/weight ratio of | | | 0.93 | 0.86 | 0.00 | — | 0.92 | — | 0.98 | 1.23 |
| monomer (A) | | | | | | | | | | |
| Total weight ratio of monomer (C)/weight | | | 13.8 | 28.6 | 114.3 | — | 38.5 | — | 37.8 | 42.5 |
| ratio of monomer (A) (%) | | | | | | | | | | |
| Total weight ratio of monomer (A) and | | | 93.3 | 86.7 | 46.7 | 44.7 | 83.3 | 46.3 | 84.0 | 84.0 |
| monomer (B) (%) | | | | | | | | | | |
| Physical | Ts (° C.) | | 82 | 81 | 83 | 81 | 86 | 86 | 88 | 92 |
| properties | Tm (° C.) | | 103 | 111 | 112 | 100 | 109 | 115 | 120 | 123 |
| of heat- | Td (° C.) | | 88 | 121 | 121 | 109 | 121 | 122 | 127 | 102 |
| expandable | Td − Ts (° C.) | | 6 | 40 | 38 | 28 | 35 | 36 | 39 | 10 |
| microspheres | Mean particle size (μm) | | 16 | 14 | 14 | 14 | 12 | 10 | 13 | 15 |
| | Encapsulation ratio (%) | | 14.2 | 18.7 | 13.3 | 10.2 | 13.3 | 12.2 | 12.2 | 15.0 |
| | Specific gravity at maximum | | 0.06 | 0.02 | 0.05 | 0.04 | 0.06 | 0.03 | 0.03 | 0.04 |
| | expansion (g/ml) | | | | | | | | | |
| | Retention | Condition A (room | 78 | 74 | 75 | 53 | 71 | 62 | 68 | 42 |
| | rate of | temperature) (%) | | | | | | | | |
| | blowing | Leakage reduction | C | C | C | D | C | D | D | D |
| | agent | of blowing agent at | | | | | | | | |
| | | normal temperature | | | | | | | | |
| | | Condition B (high | 70 | 57 | 60 | 34 | 54 | 50 | 62 | 22 |
| | | temperature (%) | | | | | | | | |
| | | Leakage reduction | C | D | D | D | D | D | D | D |
| | | of blowing agent at | | | | | | | | |
| | | high temperature | | | | | | | | |

TABLE 5

| | |
|---|---|
| AN | Acrylonitrile |
| MMA | Methyl methacrylate |
| VCl₂ | Vinylidene chloride |
| MAN | Methacrylonitrile |
| MA | Methyl acrylate |
| EA | Ethyl acrylate |
| BA | Butyl acrylate |
| MAA | Methacrylic acid |
| AAm | Acrylamide |
| Cross-linking agent A | Tetraethylene glycol diacrylate |
| Cross-linking agent B | Diethylene glycol dimethacrylate |
| Cross-linking agent C | Diethylene glycol diacrylate |
| Cross-linking agent D | Ethylene glycol dimethacrylate |
| Cross-linking agent E | Trimethylolpropane trimethacrylate |
| iC4 | Isobutane |
| iC5 | Isopentane |
| iC8 | Isooctane |
| Initiator A | Di-2-ethylhexyl peroxydicarbonate (purity 70%) |
| Initiator B | Di(3,5,5-trimethylhexanoyl)peroxide |
| | (purity: 75%) |
| Initiator C | Diisopropyl peroxydicarbonate |
| Initiator D | 2,2′-Azobis(2,4-dimethylvaleronitrile) |

As can be seen from Tables 1 to 4, when the heat-expandable microspheres included an outer shell containing a thermoplastic resin and a blowing agent that was encapsulated in the outer shell and vaporized by heating, the thermoplastic resin was a polymer of a polymerizable component containing vinylidene chloride (A) and acrylonitrile (B), and the heat-expandable microspheres satisfied the conditions 1 and 2, hollow particles capable of reducing leakage of the blowing agent over time were obtained, and expansion can be started at a relatively low temperature.

On the other hand, in a case where the condition 1 was not satisfied (Comparative Examples 1, 2, 4, 5, and 7 to 15), a case where the condition 2 was not satisfied (Comparative Examples 1, 3, 4, 6, 8, 9, 12, and 16), and a case where the vinylidene chloride (A) or the acrylonitrile (B) was not contained (Comparative Examples 11, 12, and 14), the retention rate of the blowing agent was less than 80%, and the leakage reduction of the blowing agent over time was poor.

### INDUSTRIAL APPLICABILITY

The heat-expandable microspheres of the present invention can be used as, for example, a material for weight reduction such as putties, paints, inks, sealing materials, mortar, paper clay, or ceramic, and can be used together with a base material component for molding such as injection molding, extrusion molding, or press molding to produce a molded article excellent in sound insulation, heat insulation, heat shielding, sound absorption, and the like.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1. Heat-expandable microspheres comprising:
an outer shell containing a thermoplastic resin; and
a blowing agent that is encapsulated in the outer shell and vaporizes by heating, wherein
the thermoplastic resin is a polymer of a polymerizable component containing vinylidene chloride (A) and acrylonitrile (B), and
the heat-expandable microspheres satisfy the following conditions 1 and 2:
condition 1: a weight ratio of the vinylidene chloride (A) and the acrylonitrile (B) in the polymerizable component has a relationship of Formula (I):
$$the weight ratio of the acrylonitrile ( B ) / the weight ratio of the vinylidene chloride ( A ) > 1 \qquad Formula ( I )$$
condition 2: in a derivative thermogravimetric curve (DTG) obtained by heating the heat-expandable microspheres by thermogravimetric analysis (TGA) at 10° C./min in a nitrogen atmosphere, a temperature (Td(° C.)) at which a DTG value is maximized and an expansion-starting temperature (Ts(° C.)) have a relationship of Formula (II):
$$the temperature at which the D T G value is maximized ( Td ( ° C . ) ) - the expansion - starting temperature ( Ts ( ° C . ) ) \geq 30 ° C .. \qquad Formula ( II )$$

2. The heat-expandable microspheres according to claim 1, wherein a total weight ratio of the vinylidene chloride (A) and the acrylonitrile (B) in the polymerizable component is 55 to 99.9 wt %.

3. The heat-expandable microspheres according to claim 1, wherein a weight ratio of the acrylonitrile (B) in the polymerizable component is 40 to 70 wt %.

4. Fine-particle-coated heat-expandable microspheres comprising:
the heat-expandable microspheres according to claim 1; and
fine particles coating an outer surface of an outer shell portion of the heat-expandable microspheres.

5. Hollow particles produced by expanding the heat-expandable microspheres according to claim 1.

6. Fine-particle-coated hollow particles comprising:
the hollow particles according to claim 5; and
fine particles coating an outer surface of an outer shell portion of the hollow particles.

7. A composition comprising:
the heat-expandable microspheres according to claim 1; and
a base material component.

8. A molded article obtained by molding the composition according to claim 7.

9. The heat-expandable microspheres according to claim 2, wherein a weight ratio of the acrylonitrile (B) in the polymerizable component is 40 to 70 wt %.

10. Fine-particle-coated heat-expandable microspheres comprising:
the heat-expandable microspheres according to claim 2; and
fine particles coating an outer surface of an outer shell portion of the heat-expandable microspheres.

11. Fine-particle-coated heat-expandable microspheres comprising:
the heat-expandable microspheres according to claim 3; and
fine particles coating an outer surface of an outer shell portion of the heat-expandable microspheres.

12. Hollow particles produced by expanding the heat-expandable microspheres according to claim 2.

13. Hollow particles produced by expanding the heat-expandable microspheres according to claim 3.

14. A composition comprising:
the fine-particle-coated heat-expandable microspheres according to claim 4; and
a base material component.

15. A molded article obtained by molding the composition according to claim 14.

16. A composition comprising:
the hollow particles according to claim 5; and
a base material component.

17. A molded article obtained by molding the composition according to claim 16.

18. A composition comprising:
the fine-particle-coated hollow particles according to claim 6; and
a base material component.

19. A molded article obtained by molding the composition according to claim 18.
